(19) United States
(12) Patent Application Publication
(10) Pub. No.: US 2007/0177723 A1
(43) Pub. Date: Aug. 2, 2007

(54) Method of and device for encoding a data stream

(75) Inventors: Emmanuel David Lucas Michael Frimout, Eindhoven (NL); Lincoln Sampaio Lobo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,374

(22) PCT Filed: May 24, 2005
(86) PCT No.: PCT/IB05/51693

§ 371 Date: Nov. 20, 2006

(30) Foreign Application Priority Data
May 28, 2004 (EP) 04102376.3

(51) Int. Cl. H04L 9/28

(52) U.S. Cl. 380/28

(57) ABSTRACT

A method of and devices for encoding an information stream (20) into a variable bit rate (VBR) encoded information stream (24) have been proposed. The application discloses an improved constraint variable bit rate (CVBR) encoding, which guarantees that in a particular recording mode on a record carrier, any contiguous selection from the recording on this record carrier can be copied to another record carrier having a storage capacity corresponding to said recording mode, without the necessity to employ a lower average bit rate an while still using the maximum variable bit rate freedom within the window to be archived.

The invention relates to a method of encoding an input information stream in one operation, which input information stream comprises a stream of information units [R_{IN}], comprising an encoding step of converting the input information stream into an output information stream, said output information stream comprising a variable stream of information units [R_{ENC}], the variable stream of information units being between a minimum value R_{ENC,MIN} and a maximum value R_{ENC,MAX}, while the effect of the encoding step can be influenced by means of at least one control signal [R].

The invention also relates to an encoding device for encoding an input information stream comprising a steam of information units [R_{IN}] into an output information stream, said output information stream comprising a variable stream of information units [R_{ENC}] which is between a minimum value [R_{ENC,MIN}] and a maximum value [R_{ENC,MAX}].

The invention further relates to a recording device for recording an information stream on a record carrier, said device comprising recording means for recording an information stream on the record carrier.

Such a method, encoding device and recording device are known from European patent application EP 1082856A1. This application discloses a system for encoding video information, in which the encoded information is recorded on a disc such as, for example, the digital video disc (DVD). To this end, the system comprises a compression unit having a variable output information stream (Variable Bit Rate, VBR). An example of such a compression unit is a unit operating in accordance with the MPEG2 method which is described, inter alia, in IEEE Transactions on Consumer Electronics, Vol. 41, No. 3, August 1995, pp. 504-509, “Video disc system using variable bit rate”. The system, which is known from the above-mentioned application, is suitable for encoding the information stream in one operation, e.g. in real-time encoding. Due to the variable output information stream, rendering the quantity of storage space required for recording the video information unknown in advance, and the fixed quantity of storage space present on a disc, the compression unit is operated in the limited variable output information stream mode (Constraint VBR). The variation of the output stream is dynamically limited in such a way that the quantity of storage space on a disc is sufficient for storing the desired quantity of video information. The variation of the output stream is limited by controlling quality-defining parameters of the compression unit such as, for example, the maximum value of the variable stream of information units [R_{MAX}], the minimum value of the variable stream of information units [R_{MIN}] and the quantization scale [QSC]. It is known that a compression unit with a variable output information stream yields a more efficient encoding at the same picture quality than a compression unit with a constant output information steam (Constant Bit Rate, CBR).

The known system makes it possible to encode an information stream into a variable stream of information units, in such way that for a user a substantially linear relation appears to exist between the length of time of the encoded information stream and the storage space required for storing the encoded information stream. For a given average bit rate and a given spare capacity a recording time guarantee can be given by keeping the recording bit rate within a certain margin. This model works because the start position of recording is known, i.e. an empty disc.

Recently, HDD(Hard Disk Drive)/DVD recorder combination was made available. The use of HDD allows for a function, which employs so-called continuous recording buffer. Whenever the set is on, recordings go through the continuous buffer (defined on HDD), offering e.g. “live TV pause” feature. Also timer recordings go through the continuous buffer before actually being saved as an explicit recording on a DVD disc. The user can save any section from the continuous buffer as the explicit recording. Also for this kind of operation the substantially linear relation should exist between the length of time of the encoded information stream and the storage space required for storing the encoded information stream. For example, a two-hour recording made in the continuous buffer in the two-hour mode, should fit on the disc without any transcoding. However, this situation is different from the “plain” DVD recording in the known system. Namely, the start of the saved recording is not an empty disc. Instead, it can start anywhere in the continuous buffer.

A problem in the known system is that in this situation, with unchanged CVBR mechanism, the worst-case recording size error can be twice as large as in the case of the known encoding method. This leads to inefficient use of the storage space and worsens the linear relation between the length of time of the encoded information stream and the storage space required for storing the encoded information stream. Consequently, the recording time guarantee can not be maintained.

Therefore, it is an object of the invention to provide improved way of encoding an information stream into a variable stream of information units.

This object is achieved, according to a first aspect of the invention, by a method of encoding an input information stream of the type described in the opening paragraph, which method comprises

a measuring step in which, at any instant T, a reduced quantity of information units [ENC_{OUT}(T)−R_{ENC,AVER}·T] is calculated by subtracting a predefined average value of the variable stream of information units in the output information stream [R_{ENC,AVER}] multiplied by the instant T, from a quantity of information units [ENC_{OUT}(T)] generated in the encoding step, in accordance with the formula ENC_{OUT}(T)−R_{ENC,AVER}·T;

a modification step in which a modified quantity of information units [ENC_{OUT}(T)−R_{ENC,AVER}·T+ENC_{OFF}(T,ΔT)] is calculated by adding an offset value [ENC_{OFF}(T,ΔT)] to the reduced quantity of information units [ENC_{OUT}(T)−R_{ENC,AVER}·T] in accordance with the formula ENC_{OUT}(T)−R_{ENC,AVER}·T+ENC_{OFF}(T,ΔT), where the offset value [ENC_{OFF}(T,ΔT)] is chosen in dependence on values of reduced quantity of information units [ENC_{OUT}(T_{X})−R_{ENC,AVER}·T_{X}] for specific instants T_{X} within a time interval [T−ΔT,T] where ΔT represents a predefined time period, and in dependence of at least one signalizing signal [S] generated in at least one comparison step executed for at least one value of modified quantity of information units [ENC_{OUT}(T_{X})−R_{ENC,AVER}·T_{X}+ENC_{OFF}(T,ΔT)];

a comparison step in which the modified quantity of information units [ENC_{OUT}(T)−R_{ENC,AVER}·T+ENC_{OFF}(T,ΔT)] is compared with at least one criterion, and in which at least one signalizing signal [S] is generated; and

a control step in which at least one control signal [R] is generated, in which the state of the control signal depends on the state of at least one of the signalizing signals [S] generated in the comparison step, and which control signal influences the effect of the encoding step.

At any instant T, the quantity of information units ENC_{OUT}(T) generated in the encoding step is measured. This quantity is reduced by a predefined average value of the variable stream of information units in the output information stream, R_{ENC,AVER}, multiplied by the time T. By means of these data, the variable stream (Variable Bit Rate) of information units generated in the encoding step and ranging between a minimum value R_{ENC,MIN} and a maximum value R_{ENC,MAX} can be represented at any instant T by a constant stream (Constant Bit Rate) of information units having a predefined value R_{ENC,AVER} and the reduced quantity of [ENC_{OUT}(T)−R_{ENC,AVER}·T] information units which are stored in an imaginary buffer (referred to as virtual buffer). Due to the constant stream of information units, a linear relation can be established between the storage space on a disc, expressed in information units D_{SIZE}, and the quantity of information expressed in length of time T_{DISC} that can be stored on the disc, namely T_{DISC}=D_{SIZE}/R_{ENC,AVER}. Since the stream of information units generated in the encoding step is actually a variable stream, T_{DISC} is actually an approximation. The deviation of the approximated value of T_{DISC} from the real value of T_{DISC} is (ENC_{OUT}(T)−R_{ENC,AVER}−T)/R_{ENC,AVER}.

Further, the reduced quantity of [ENC_{OUT}(T)−R_{ENC,AVER}·T] information units is modified by adding an offset value [ENC_{OFF}(T,ΔT)] to the reduced quantity of information units [ENC_{OUT}(T)−R_{ENC,AVER}·T] in accordance with the formula ENC_{OUT}(T)−R_{ENC,AVER}·T+ENC_{OFF}(T,ΔT). The offset value [ENC_{OFF}(T,ΔT)] allows for fine-tuning of the reduced quantity of information units [ENC_{OUT}(T)−R_{ENC,AVER}·T] using a limited history time window ΔT. This window defines the time interval [T−ΔT,T]. In other words, the fullness of the virtual buffer, i.e. the number of information units which are stored in the virtual buffer, at any instant T, is dynamically adjusted using its distribution within the limited history time window ΔT. The value of ΔT is chosen in dependence of the recording mode. For example, if the recording mode corresponds to two-hour recording on the record carrier (T_{DISC}), the time window ΔT is equal to two hours (ΔT=T_{DISC}). The offset value [ENC_{OFF}(T,ΔT)] is determined by checking values of reduced quantity of information units [ENC_{OUT}(T_{X})−R_{ENC,AVER}·T_{X}] for specific instants T_{X} within a time interval [T−ΔT,T] where ΔT represents a predefined time period, and in dependence of at least one signalizing signal [S] generated for at least one value of modified quantity of information units [ENC_{OUT}(T_{X})−R_{ENC,AVER}·T_{X}+ENC_{OFF}(T,ΔT)]. The concept of the limited history time window ΔT improves the encoding by making it more flexible—the encoder has more freedom to make optimal use of the variable bit rate.

An embodiment of the method according to the invention is characterized in that

a first criterion is α·T_{VB}·R_{ENC,AVER} and a second criterion is −(1−α)·T_{VB}·R_{ENC,AVER}, in which T_{VB} represents a predefined time constant and in which α represents a constant predefined value such that 0≦α≦1, and in that

a first signalizing signal [S_{OVER}] acquires a predetermined value if the equation
ENC_{OUT}(T)−R_{ENC,AVER}·T+ENC_{OFF}(T,ΔT)≧α·T_{VB}·R_{ENC,AVER}
is true, and in that a second signalizing signal [S_{UNDER}] acquires a predetermined value if the equation
ENC_{OUT}(T)−R_{ENC,AVER·}T+ENC_{OFF}(T,ΔT)≧−(1−α)·T_{VB·}R_{ENC,AVER}
is true, and in that
at least one control signal influences the effect of the encoding step in such a way that the maximum value of the variable stream of information units in the output information stream [R_{ENC, MAX}] will be equal to R_{ENC,AVER} if the first signalizing signal [S_{OVER}] has the predetermined value, and in that
at least one control signal influences the effect of the encoding step in such a way that the minimum value of the variable stream of information units in the output information stream [R_{ENC, MIN}] will be equal to R_{ENC,AVER} if the second signalizing signal [S_{UNDER}] has the predetermined value.

In this embodiment, the modified quantity of information units stored in the virtual buffer, ENC_{OUT}(T)−R_{ENC,AVER}·T+ENC_{OFF}(T,ΔT), is limited to a value between −(1−α)·T_{VB}·R_{ENC,AVER} and α·T_{VB}·R_{ENC,AVER}. The predefined time constant T_{VB} is equal to half of the value used in the conventional CVBR mechanism for the given value of R_{ENC,AVER}. By adapting the minimum value R_{ENC,MIN} or the maximum value R_{ENC,MAX} of the variable output information stream, it is prevented that the quantity of information units stored in the virtual buffer, ENC_{OUT}(T)−R_{ENC,AVER}·T+ENC_{OFF}(T,ΔT) acquires a value outside the range between −(1−α)·T_{VB}·R_{ENC,AVER} and α·T_{VB}·R_{ENC,AVER} and the spare capacity is doubled.

In a further embodiment of the method, according to the invention, the predefined constant α has a value greater than 0.8. This is advantageous in view of encoding of video streams comprising complex scenes as in real-time DVD+RW recording.

In another embodiment of the method, according to the invention, the offset value ENC_{OFF}(T,ΔT) is chosen such that the equation
ENC_{OUT}(T_{X})−R_{ENC,AVER}·T_{X}+ENC_{OFF}(T,ΔT)≦α·T_{VB}·R_{ENC,AVER}
is true and the equation
ENC_{OUT}(T_{X})−R_{ENC,AVER}·T_{X}+ENC_{OFF}(T,ΔT)≧−(1−α)·T_{VB}·R_{ENC,AVER}
is true for all specific instants T_{X} within the time interval [T−ΔT,T].

It is advantageous, if the offset value ENC_{OFF}(T,ΔT) is chosen such that there exists an instant T_{MIN} within the time interval [T−ΔT,T], for which the equation
ENC_{OUT}(T_{MIN})−R_{ENC,AVER}·T_{MIN}+ENC_{OFF}(T,ΔT)=−(1−α)·T_{VB}·R_{ENC,AVER}
is true. This allows for keeping the bit rate of the output information stream as high as possible within the given limits.

An embodiment of the method according to the invention is characterized in that all states of the control signals [R] to be generated in the control step are laid down in elements of a table, and in that an element from the table is selected in dependence upon the state of at least one signalizing signal [S], and in that the state of the control signals laid down in the selected element is generated.

In a table, referred to as look-up table, with N elements, all states of the control signals to be generated in the control step are laid down in the elements of the look-up table. Per element, the states of the control signals are laid down for those control signals, which occur simultaneously. A given control signal may be incorporated in a plurality of elements of the look-up table, in which case the fixed value of the control signal may deviate for each element.

Dependent on the state of at least one signalizing signal, a given element from the look-up table is selected. The control signals incorporated in the selected element subsequently acquire the values laid down in the selected element. In another embodiment of the method according to the invention at least one signalizing signal [S] comprises a derivative of the quantity of information units [ENC_{OUT}(T)−R_{ENC,AVER}·T], calculated in the measuring step, as a function of time T.

The signalizing signal, generated in the comparison step, comprising the time derivative (ENC_{OUT}(T)−R_{ENC,AVER}·T)/T may signalize a trend in the quantity of information units stored in the virtual buffer, ENC_{OUT}(T)−R_{ENC,AVER}·T. Subsequently, control signals, depending on the signalizing signal, may be generated in dependence upon the signalized trend, which control signals influence the effect of the encoding step and hence the quantity of information units ENC_{OUT}(T) generated in this encoding step.

An embodiment of the method according to the invention is characterized in that the value of the quantity of information units [ENC_{OUT}(T)−R_{ENC,AVER}·T] calculated in the measuring step is recorded.

The value of the quantity of information units [ENC_{OUT}(T)−R_{ENC,AVER}·T] calculated in the measuring step is recorded in such a way that this value may be used, for example, for choosing the offset value ENC_{OFF}(T,ΔT) or as an initial value ENC_{OUT}(0) upon a subsequent execution of the method.

The value of the quantity of information units [ENC_{OUT}(T)−R_{ENC,AVER}·T] calculated in the measuring step may be recorded, for example, once upon termination of the method, or at more instants with regular intervals in between.

An embodiment of the method according to the invention is characterized in that, in the control step, at least one control signal is generated, the state of the control signal depending on an externally supplied indication signal which is typical of the contents of the input information stream.

An indication signal supplied externally, which is typical of the contents of the input information stream, controls the encoding step via at least one control signal. This control may be such that, for an input information stream comprising a given type or kind of information, the encoding step for this type of information proceeds optimally. The indication signal may be supplied, for example, manually or come from the same source as the input information stream.

According to a second aspect of the invention an encoding device of the type described in the opening paragraph is provided, comprising:

compression means for converting the input information stream into the output information stream;

measuring means for measuring a quantity of information units [ENC_{OUT}(T)] generated by the encoding device;

calculating means for calculating, at any instant T, a reduced quantity of information units [ENC_{OUT}(T)−R_{ENC,AVER}·T] by subtracting a predefined average value of the variable stream of information units in the output information stream [R_{ENC,AVER}] multiplied by the instant T, from the quantity of information units [ENC_{OUT}(T)], in accordance with the formula ENC_{OUT}(T)−R_{ENC,AVER}·T, and

for calculating a modified quantity of information units [ENC_{OUT}(T)−R_{ENC,AVER}·T+ENC_{OFF}(T,ΔT)] by adding an offset value [ENC_{OFF}(T,ΔT)] to the reduced quantity of information units [ENC_{OUT}(T)−R_{ENC,AVER}·T] in accordance with the formula ENC_{OUT}(T)−R_{ENC,AVER}·T+ENC_{OFF}(T,ΔT), where the offset value [ENC_{OFF}(T,ΔT)] is chosen in dependence on values of reduced quantity of information units [ENC_{OUT}(T_{X})−R_{ENC,AVER}·T_{X}] for specific instants T_{X} within a time interval [T−ΔT,T] where ΔT represents a predefined time period, and in dependence of at least one signalizing signal [S] generated by comparing means for at least one value of modified quantity of information units [ENC_{OUT}(T_{X})−R_{ENC,AVER}·T_{X}+ENC_{OFF}(T,ΔT)];

comparing means for comparing the modified quantity of information units [ENC_{OUT}(T)−R_{ENC,AVER}·T+ENC_{OFF}(T,ΔT)] with at least one criterion and for generating at least one signalizing signal [S]; and

control means for generating at least one control signal for controlling the compression means in dependence on the state of at least one of the signalizing signals.

According to a third aspect of the invention a recording device of the type described in the opening paragraph is provided, characterized in that it comprises an encoding device as described with respect to the second aspect of the invention.

These and other aspects of the invention will be apparent from and will be elucidated with reference to the embodiments described by way of example in the following description and with reference to the accompanying drawings, in which:

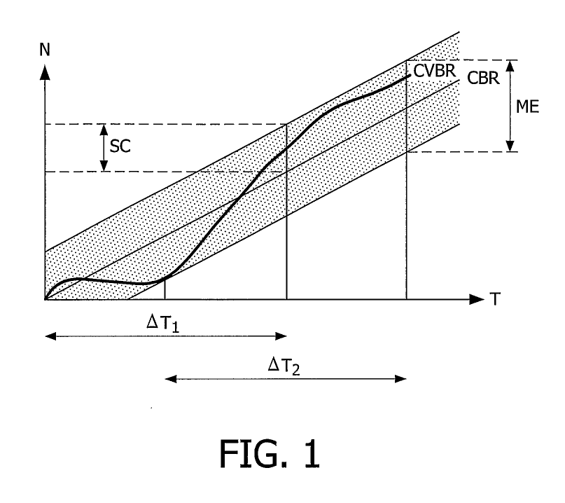

FIG. 1 shows a principle of CVBR and illustrates a problem of the prior art,

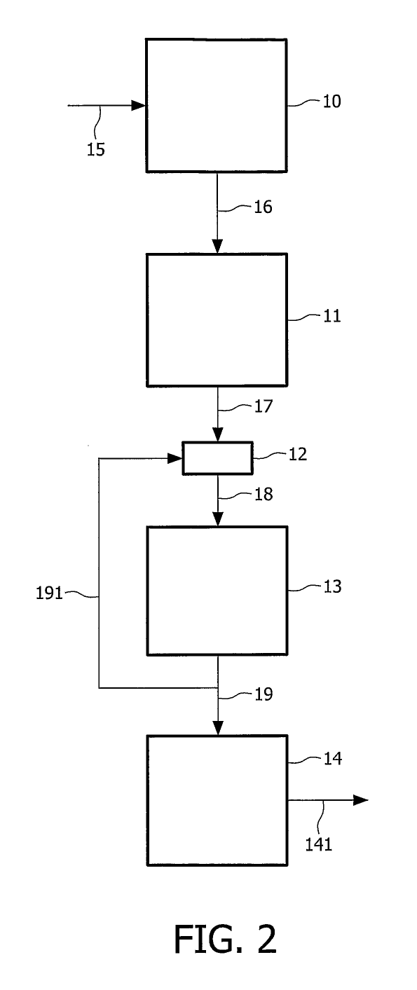

FIG. 2 shows an example of a method of encoding an input information stream into an output information stream, in accordance with the invention,

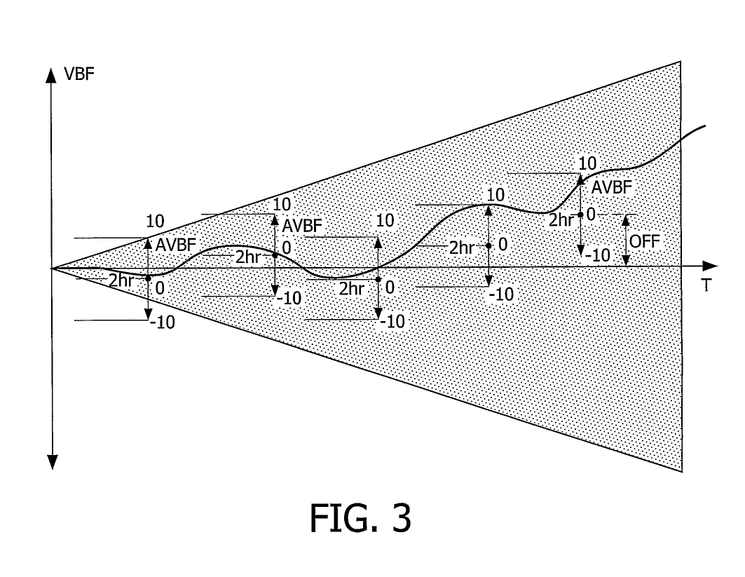

FIG. 3 illustrates a concept of a windowed CVBR, in accordance with the invention,

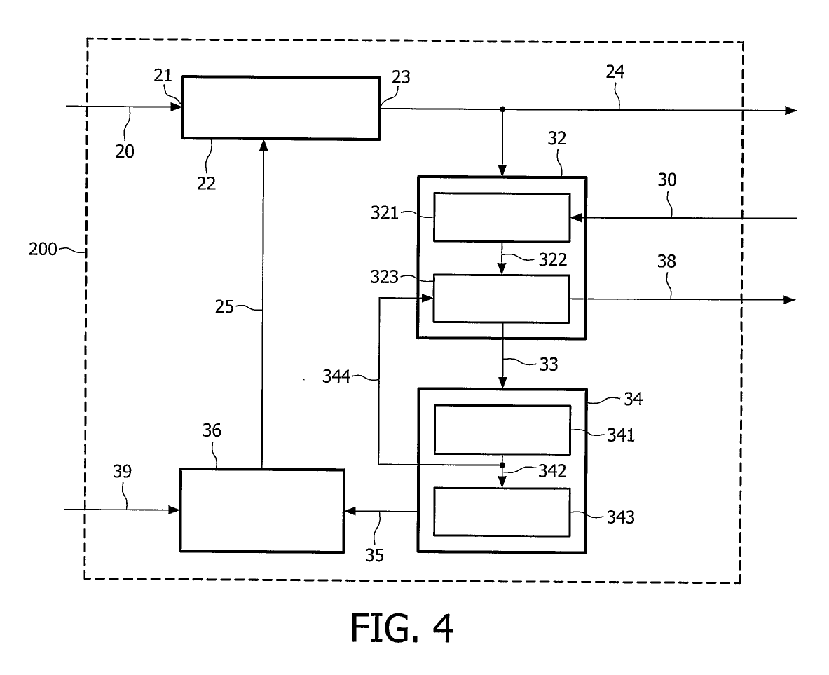

FIG. 4 shows an example of a block diagram of an encoding device, in accordance with the invention,

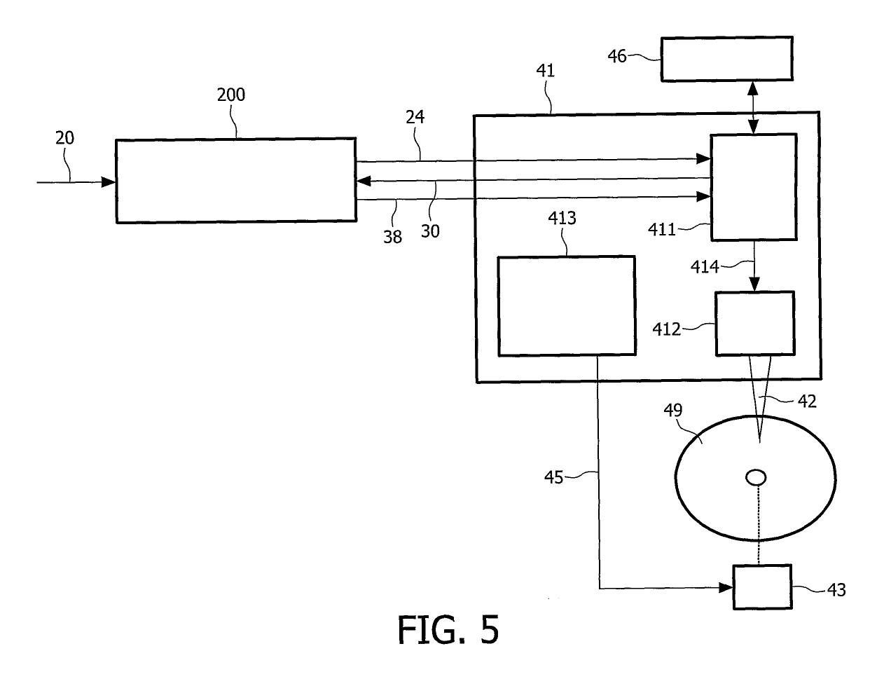

FIG. 5 shows an example of a block diagram of a recording device, in accordance with the invention.

Corresponding elements in different Figures have identical reference numerals and symbols.

FIG. 1 shows a principle of CVBR as known from the prior art. A quantity of information units in the output information stream N is depicted as a function of time T. This quantity can be expressed as e.g. a number of bits in the output stream generated by MPEG2 encoder. CBR represents the number of bits generated in case of the stream with Constant Bit Rate. For a given average bit rate, storage capacity and spare capacity SC (these parameters defining a particular recording mode), a recording time ΔT guarantee can be given by keeping the recording bit rate within a certain margin, i.e. by applying Constrained Variable Bit Rate. This is illustrated by the curve CVBR. However this works only for recordings starting at the beginning of the curve, in this example indicated by ΔT₁. This is the case when, for example, the output stream is generated in the recording mode corresponding to two-hour recording on a disc and directly recorded on such disc. There is no guarantee that recording at ΔT₂ of the same stream, but which starts at a later time will fit on the same kind of disc—the worst case recording size error ME can be twice as large as for recording at ΔT₁. This can happen when, for example, a part of a long stream recorded on one medium (e.g. HDD) is copied to another medium (e.g. a DVD+RW disc) without transcoding, i.e. without secondary encoding.

FIG. 2 shows a flow chart of an example of a method according to the invention. In an encoding step 10, an input information stream 15 is converted into an output information stream 16. The quantity of information units, ENC_{OUT}(T), in the output information stream 16 generated until the instant T in the encoding step 10 is measured in a measuring step 11 and reduced by a predefined average value of the stream of information Units, R_{ENC,AVER}, in the output information stream 16, multiplied by the instant T, which results in a value 17 of a reduced quantity of information units ENC_{OUT}(T)−R_{ENC,AVER}·T. This value represents the fullness of the virtual buffer, i.e. the accumulated difference between actual amount of data generated and the nominal amount of data if constant bit rate was used. The virtual buffer is said to be empty when the accumulated amount of data generated is exactly the expected nominal value. Whenever the generated bit rate is higher than the nominal value, R_{ENC,AVER}, the buffer fullness increases; whenever the generated bit rate is lower than the nominal value, the virtual buffer fullness decreases. The virtual buffer is said to be full when the amount of generated data exceeds the nominal expected value by a value equal to the spare capacity; if the bit rate would remain higher that the nominal value the virtual buffer would overflow, meaning that the guarantee of a certain recording time would not be kept. Conversely, the virtual buffer may also have a negative fullness, meaning that less data has been generated than expected. Although this does not affect the ability of having a certain minimum recording on the disc (because actually the recording time in this situation will be larger than nominal), it is still undesired to have a too large negative buffer fullness, because it would be confusing for the user if the deviation from nominal recording time was too large. The virtual buffer is not directly associated with any real storage area. The value 17 of the reduced quantity of information units ENC_{OUT}(T)−R_{ENC,AVER}·T is passed on to a modification step 12. Upon the start of the method, an initial value, ENC_{OUT}(0), may be assigned to the generated quantity of information units.

In the modification step 12, the value 17 is modified by adding to it an offset value [ENC_{OFF}(T,ΔT)] in accordance with the formula ENC_{OUT}(T)−R_{ENC,AVER}·T+ENC_{OFF}(T,ΔT). The offset value is chosen using the limited history time window ΔT. This is done by checking values of reduced quantity of information units [ENC_{OUT}(T_{X})−R_{ENC,AVER}·T_{X}] for specific instants T_{X} within a time interval [T−ΔT,T], where ΔT represents a predefined time period. For example, the offset value [ENC_{OFF}(T,ΔT)] may depend on maximal and minimal values of [ENC_{OUT}(T_{X})−R_{ENC,AVER}·T_{X}]. The offset value [ENC_{OFF}(T,ΔT)] must lead to values consistent with at least one criterion used in a comparison step. Therefore during calculation of the offset value a feed-back mechanism is used in order to check this consistency. Depending on a particular embodiment, at least one value 18 of a modified quantity of information units [ENC_{OUT}(T_{X})−R_{ENC,AVER}·T_{X}+ENC_{OFF}(T,ΔT)] is passed on to the comparison step 13. Then, a generated signalizing signal 19 is passed back 191 to the modification step 12 to be used to adjust the offset value. Once the offset value [ENC_{OFF}(T,ΔT)] is set, a value 18 of a modified quantity of information units [ENC_{OUT}(T)−R_{ENC,AVER}·T+ENC_{OFF}(T,ΔT)] is passed on to the comparison step 13.

In the comparison step 13, the value 18 is compared with at least one criterion. Moreover, at least one signalizing signal 19 is generated in the comparison step 18. The state of one of the signalizing signals 19 depends on the result of the comparison of the value 18 with at least one criterion. The signalizing signals 19 are passed on to a control step 14 in which control signals 141 are generated, with the state of the control signals depending on at least one of the signalizing signals 19.

In the comparison step, the quantity of information units stored in the virtual buffer is compared with at least one criterion, and at least one signalizing signal is generated, with the state of the signalizing signals being dependent on the result of the comparisons. Subsequently, control signals influencing the effect of the encoding step and hence the quantity of information units ENC_{OUT}(T) generated in this encoding step are generated in dependence upon the signalizing signal. Via the mechanism of signalizing signals and control signals, the quantity of information units stored in the virtual buffer, and hence the deviation from the approximated value ΔT with respect to the real value of ΔT can be influenced.

The comparison step criteria may be fixed criteria, which are always identical at the start of the method. However, it is alternatively possible to modify the criteria in dependence upon previous executions of the method. These so-called self-learning criteria do not always need to be identical at the start of the method.

The control signals 141 are used for influencing the effect of the encoding step 10 in order to guarantee that no virtual buffer overflow happens. As the virtual buffer becomes increasingly fuller the encoding settings are adapted in order to try to make it generate reduced bit rates; when the virtual buffer is completely full the encoding settings are such that the generated bit rate is guaranteed to be lower or equal the nominal bit rate, independently of the video content. When the virtual buffer becomes emptier the encoder is increasingly given more freedom to generate higher bit rates; when the buffer fullness has maximum negative value the encoder settings are such that the generated bit rate is guaranteed to be higher or equal the nominal bit rate, if needed by the use of byte stuffing.

As a practical way of implementing this feedback mechanism, the virtual buffer fullness can be divided in a series of bands, and for each band a series of encoder settings is used. As such, the virtual buffer is quantized into a number of levels (e.g. 21 levels from −10 to 10 in one implementation).

In an embodiment of the method, the modified quantity of information units stored in the virtual buffer, ENC_{OUT}(T)−R_{ENC,AVER}·T+ENC_{OFF}(T,ΔT), is limited to a value between

−(1−α)·T_{VB}·R_{ENC,AVER} and α·T_{VB}·R_{ENC,AVER}. Here T_{VB} is equal to half of the value used in the conventional CVBR mechanism due to the uncertainty of the virtual buffer fullness starting point for an arbitrary recording (see also FIG. 1). By adapting the minimum value R_{ENC,MIN} or the maximum value R_{ENC,MAX} of the variable output information stream, it is prevented that the quantity of information units stored in the virtual buffer, ENC_{OUT}(T)−R_{ENC,AVER}·T+ENC_{OFF}(T,ΔT), acquires a value outside the range between −(1−α)·T_{VB}·R_{ENC,AVER} and α·T_{VB}·R_{ENC,AVER}.

The nominal bit rate, R_{ENC,AVER}, can be lowered such that the spare capacity after ΔT of recording is doubled, i.e. twice the virtual buffer size.

Typical α>0.8 such that the possible deviation for difficult scenes is as close as possible to the situation in real-time DVD+RW recording.

In another embodiment, padding at zero disallows any negative deviation, resulting in a maximum worse case deviation of T_{VB}·R_{ENC,AVER}. This is a variant with α=1.

FIG. 3 illustrates a concept of a windowed CVBR, i.e. the concept of dynamically adjusting the fullness of the virtual buffer VBF using its distribution within the limited history time window (in this example ΔT=2 hours). In this example α=1. Several time windows are shown with corresponding adjusted virtual buffer fullness's AVBF. The fullness of the virtual buffer is quantized into levels from −10 to 10. In this embodiment, for each AVBF, the virtual buffer fullness is kept within a band defined by the condition:
ENC_{OUT}(T_{X})−R_{ENC,AVER}·T_{X}+ENC_{OFF}(T,ΔT)≦T_{VB}·R_{ENC,AVER} and
ENC_{OUT}(T_{X})−R_{ENC,AVER}·T_{X}+ENC_{OFF}(T,ΔT)≧0 (as α=1),
for all specific instants T_{X} within a time interval [T−ΔT,T]. Moreover, for each AVBF, the offset value ENC_{OFF}(T,ΔT) is chosen to fulfill the condition ENC_{OUT}(T_{MIN})−R_{ENC,AVER}·T_{MIN}+ENC_{OFF}(T,ΔT)=0. If the buffer fullness is close to the minimum and falling, the applied offset will adapt the windowed buffer fullness to the new lower boundary, i.e. AVBF in FIG. 3 will be shifted down, if this does not cause any part of the buffer fullness of the last two hours to violate the CVBR buffer constraints. Alternatively, when the buffer fullness increases, the applied offset will shift AVBF up. An example of the offset for a specific history time window is indicated by OFF in FIG. 3.

A more formal description of these rules to offset the windowed virtual buffer fullness, in this case, is given below.

Definitions:

B=buffer fullness;

Buff=virtual buffer size;

Rn=nominal rate, Ra—actual rate;

dT—time interval;

Q(B) is the quantization of the buffer fullness B in the rate control levels—10 . . . 0 . . . 10.

Initialise:

Bmin=0; Bmax=0; B(0)=0; offset=0;

Loop for all measurement points n:

B(n)=B(n−1)+(Ra−Rn)*dT;
/*Shift up:*/
lastBmin=Bmin;
Bmin=MIN(B(n−2h)...B(n));
If Bmin>lastBmin then

offset=offset+(Bmin−lastBmin);

/*Shift down:*/
Bmax=MAX(B(n−2h)...B(n));
If Q(B(n)−offset)==0 then

If (Bmax−Bmin)<Buff then{

stuffing(OFF);
Offset=offset−(Ra−Rn)*dT; /*Clip on zero level*/

}else

stuffing(ON);

BufferFeedbackRateControl(B+offset).

FIG. 4 shows an example of a block diagram of an encoding device 200 according to the invention. The encoding device is capable of performing the method of encoding as described in reference to FIG. 2. The encoding device 200 comprises a compression unit 22, which converts an input information stream 20 supplied via input 21 into an output information stream 24 at an output 23. The compression unit 22 is of a conventional type such as, for example, MPEG2 for video signals in accordance with ISO/IEC13818-2 or for audio signals in accordance with ISO-IEC13818-3. The output information stream 24 comprises a variable stream of information units (Variable Bit Rate, VBR), which variable stream is controllable via control signals 25.

A measuring block 32 comprises means 321 for measuring the quantity of information units, ENC_{OUT}(T), generated by the encoding device. Via signal 30, an initial value may be assigned to the quantity of information units, ENC_{OUT}(0), generated by the encoding device. The recorded quantity of information units, ENC_{OUT}(T), generated by the encoding device is passed on via a signal 322 to means 323, also present in measuring block 32, for calculating the recorded quantity of information units [ENC_{OUT}(T)] at any instant T, reduced by a predefined average value of the variable stream of information units in the output information stream [R_{ENC,AVER}], multiplied by the instant T in accordance with the formula ENC_{OUT}(T)−R_{ENC,AVER}·T. Further, the means 323 are for calculating a modified quantity of information units [ENC_{OUT}(T)−R_{ENC,AVER}·T+ENC_{OFF}(T,ΔT)] by adding an offset value [ENC_{OFF}(T,ΔT)] to the reduced quantity of information units [ENC_{OUT}(T)−R_{ENC,AVER}·T] in accordance with the formula ENC_{OUT}(T)−R_{ENC,AVER}·T+ENC_{OFF}(T,ΔT), where the offset value [ENC_{OFF}(T,ΔT)] is chosen in dependence on values of reduced quantity of information units [ENC_{OUT}(T_{X})−R_{ENC,AVER}·T_{X}] for specific instants T_{X} within a time interval [T−ΔT,T] where ΔT represents a predefined time period, and in dependence of at least one signalizing signal [S] generated by comparing means for at least one value of modified quantity of information units [ENC_{OUT}(T_{X})−R_{ENC,AVER}·T_{X}+ENC_{OFF}(T,ΔT)], as described above in reference to FIG. 2. The offset value is adjusted using feedback between a comparing block 34 and the calculating means 324, provided by a signal 344.

The value of the modified quantity of information units [ENC_{OUT}(T)−R_{ENC,AVER}·T+ENC_{OFF}(T,ΔT)] determined in block 32 is passed on via a signal 33 to a comparing block 34. In this comparing block 34, the modified quantity of information units [ENC_{OUT}(T)−R_{ENC,AVER}·T+ENC_{OFF}(T,ΔT)] is compared by comparison means 341 with at least one criterion. At least one signalizing signal 35 is generated by means in block 343, with the state of the signalizing signals 35 being dependent, inter alia, via signal 342 on the result of the comparisons performed by the comparison means 341. At specific instants T_{Y}, the value for the quantity of information units, ENC_{OUT}(T_{Y})−R_{ENC,AVER}·T_{Y} determined in block 32 may become available via signal 38.

Control block 36 comprises means for generating at least one control signal 25 such as, for example, R_{MAX}, R_{MIN} and QSC, with the state of the control signals 25 being dependent on at least one of the signalizing signals 35. The state of the control signals 25 can be influenced via an indication signal 39, which is typical of the contents of the input information stream 20.

The encoding device 200 comprises control circuitry, for example a microprocessor, a program memory and control gates, for performing the procedures and functions according to the invention as described above.

FIG. 5 is an example of a block diagram of a recording device according to the invention for writing information on a disc-shaped record carrier 49. The invention may be alternatively used for writable record carriers of a shape different from these disc-shaped record carriers, such as, for example, an optical or magnetic tape.

The recording device comprises an encoding device 200 according to the invention, as described in reference to FIG. 4. The recording device also comprises a block with recording means 41 comprising a read/write unit 411, a read/write head 412 for, inter alia, writing information on the record carrier 49, and a system drive 413.

An input information stream 20 is converted by the encoding device into an output information stream 24, which stream is subsequently converted in the read/write unit 411 into a write signal 414. The write signal 414 is coupled to the read/write head 412. The record carrier 49 is rotationally driven by drive means 43 which are controlled by the system drive 413 via a signal 45. The read/write head 412 scans the record carrier 49 via a beam 42 and reads/writes patterns of marks therein, which marks represent information such as, for example, on a CD or a DVD. Alternatively, the marks maybe in the form of areas with a direction of magnetization different from their surroundings as, for example, in case of HDD (Hard Disk Drive).

The value for the quantity of information units ENC_{OUT}(T_{Y})−R_{ENC,AVER}·T_{Y} determined in the encoding device 200 may be applied to the read/write unit 411 which subsequently converts signal 38 into a write signal 414. In this way, the value of the determined quantity of information units, ENC_{OUT}(T_{Y})−R_{ENC,AVER}·T_{Y}, can be recorded on the record carrier 49.

An initial value can be assigned via signal 30 to the quantity of information units, ENC_{OUT}(0), generated by the encoding device 200. Signal 30 originates via read/write head 412 and read/write unit 411 from information, which is present on the record carrier 49. This information may consist of a previously fixed, determined quantity of information units, ENC_{OUT}(T_{Y})−R_{ENC,AVER}·T_{Y}. The information may alternatively consist of information derived from a previously fixed, determined quantity of information units, ENC_{OUT}(T_{Y})−R_{ENC,AVER}·T_{Y}. This is the case, for example, if a part of or the entire output information stream 24 previously recorded on the record carrier 49 is erased or overwritten.

Alternatively, signal 30 may originate via read/write head 412 and read/write unit 411 from information, which is present on the record carrier 49 and recorded in a table of contents on the record carrier.

In an embodiment, the recording device is provided with storage unit 46, such as, for example, HDD, for transiently storing the output information stream 24 before recording on the record carrier 49. The signals 24, 30 and 38 can be directly fed/accessed to/from the storage unit 46.

The storage unit 46 can function as the main storage medium, such as, for example, the continuous recording buffer described above. In this case, the recording medium 49 can be used to archive (parts of) recordings made on the storage unit 46.

A computer program product according to the invention is operative to cause the encoding device 200 to perform methods and functions as described in reference to embodiments presented above.

Whilst the invention has been described with reference to preferred embodiments thereof, it is to be understood that these are not limiting examples. Thus, various modifications may become apparent to those skilled in the art, without departing from the scope of the invention, as defined by the claims. Furthermore, the invention lies in each and every novel feature or combination of features described above. It is noted, that the invention may be implemented by means of a general purpose processor executing a computer program or by dedicated hardware or by a combination of the two, and that in this document the word “comprising” does not exclude the presence of other elements or steps than those listed and the word “a” or “an” preceding an element does not exclude the presence of a plurality of such elements, that any reference signs do not limit the scope of the claims, that “means” may be represented by a single item or a plurality and that several “means” may be represented by the same item of hardware.

1. A method of encoding an input information stream in real-time, which input information stream comprises a stream of information units [R_{IN}], comprising:
an encoding step of converting the input information stream into an output information stream, said output information stream comprising a variable stream of information units [R_{ENC}], the variable stream of information units being between a minimum value R_{ENC,MIN} and a maximum value R_{ENC,MAX}, while the effect of the encoding step can be influenced by means of at least one control signal [R];
a measuring step in which, at any instant T, a reduced quantity of information units [ENC_{OUT}(T)−R_{ENC,AVER}·T] is calculated by subtracting a predefined average value of the variable stream of information units in the output information stream [R_{ENC,AVER}] multiplied by the instant T, from a quantity of information units [ENC_{OUT}(T)] generated in the encoding step, in accordance with the formula ENC_{OUT}(T)−R_{ENC,AVER}·T;
a modification step in which a modified quantity of information units [ENC_{OUT}(T)−R_{ENC,AVER}·T+ENC_{OFF}(T,ΔT)] is calculated by adding an offset value [ENC_{OFF}(T,ΔT)] to the reduced quantity of information units [ENC_{OUT}(T)−R_{ENC,AVER}·T] in accordance with the formula ENC_{OUT}(T)−R_{ENC,AVER}·T+ENC_{OFF}(T, ΔT), where the offset value [ENC_{OFF}(T, ΔT)] is chosen in dependence on values of reduced quantity of information units [ENC_{OUT}(T_{X})−R_{ENC,AVER}·T_{X}] for specific instants T_{X} within a time interval [T−ΔT,T] where ΔT represents a predefined time period, and in dependence of at least one signalizing signal [S] generated in at least one comparison step executed for at least one value of modified quantity of information units [ENC_{OUT}(T_{X})−R_{ENC,AVER}·T_{X}+ENC_{OFF}(T, ΔT)];
a comparison step in which the modified quantity of information units [ENC_{OUT}(T)−R_{ENC,AVER}·T+ENC_{OFF}(T, ΔT)] is compared with at least one criterion, and in which at least one signalizing signal [S] is generated; and
a control step in which at least one control signal [R] is generated, in which the state of the control signal depends on the state of at least one of the signalizing signals [S] generated in the comparison step, and which control signal influences the effect of the encoding step.

2. A method as claimed in claim 1, characterized in that
a first criterion is α·T_{VB}·R_{ENC,AVER} and a second criterion is −(1−α)·T_{VB}·R_{ENC,AVER}, in which T_{VB} represents a predefined time constant and in which a represents a constant predefined value such that 0≦α≦1, and in that
a first signalizing signal [S_{OVER}] acquires a predetermined value if the equation
ENC_{OUT}(T)−R_{ENC,AVER}·T+ENC_{OFF}(T,ΔT)≧α·T_{VB}·R_{ENC,AVER}
is true, and in that a second signalizing signal [S_{UNDER}] acquires a predetermined value if the equation
ENC_{OUT}(T)−R_{ENC,AVER·}T+ENC_{OFF}(T,ΔT)≦−(1−α)·T_{VB}·R_{ENC,AVER}
is true, and in that at least one control signal influences the effect of the encoding step in such a way that the maximum value of the variable stream of information units in the output information stream [R_{ENC, MAX}] will be equal to R_{ENC,AVER} if the first signalizing signal [S_{OVER}] has the predetermined value, and in that
at least one control signal influences the effect of the encoding step in such a way that the minimum value of the variable stream of information units in the output information stream [R_{ENC, MIN}] will be equal to R_{ENC,AVER} if the second signalizing signal [S_{UNDER}] has the predetermined value.

3. A method as claimed in claim 2, characterized in that the predefined constant α has a value greater than 0.8.

4. A method as claimed in claim 2, characterized in that the offset value ENC_{OFF}(T,ΔT) is chosen such that the equation
ENC_{OUT}(T_{X})−R_{ENC,AVER}·T_{X+ENC}_{OFF}(T,ΔT)≦α·T_{VB}·R_{ENC,AVER}
is true and the equation
ENC_{OUT}(T_{X})−R_{ENC,AVER}·T_{X}+ENC_{OFF}(T,ΔT)≧−(1−α)·T_{VB}·R_{ENC,AVER}
is true for all specific instants T_{X} within the time interval [T−ΔT,T].

5. A method as claimed in claim 4, characterized in that the offset value ENC_{OFF}(T,ΔT) is chosen such that there exists an instant T_{MIN} within the time interval
[T−ΔT,T], for which the equation
ENC_{OUT}(T_{MIN})−R_{ENC,AVER}·T_{MIN}+ENC_{OFF}(T,ΔT)=−(1−α)·T_{VB}·R_{ENC,AVER}
is true.

6. A method as claimed in claim 1, characterized in that
all states of the control signals [R] to be generated in the control step are laid down in elements of a table, and in that an element from the table is selected in dependence upon the state of at least one signalizing signal [S], and in that
the state of the control signals laid down in the selected element is generated.

7. A method as claimed in claim 1, characterized in that at least one signalizing signal [S] comprises a derivative of the quantity of information units [ENC_{OUT}(T)−R_{ENC,AVER}·T], recorded in the measuring step, as a function of time T.

8. A method as claimed in claim 1, characterized in that the value of the reduced quantity of information units [ENC_{OUT}(T)−R_{ENC,AVER}·T] calculated in the measuring step is recorded.

9. A method as claimed in claim 1, characterized in that, in the control step, at least one control signal is generated, the state of the control signal depending on an externally supplied indication signal which is typical of the contents of the input information stream.

10. An encoding device for encoding an input information stream comprising a stream of information units [R_{IN}] into an output information stream, said output information stream comprising a variable stream of information units [R_{ENC}], which variable stream of information units is between a minimum value [R_{ENC,MIN}] and a maximum value [R_{ENC,MAX}], the device comprising:
compression means for converting the input information stream into the output information stream;
measuring means for measuring a quantity of information units [ENC_{OUT}(T)] generated by the encoding device;
calculating means for calculating, at any instant T, a reduced quantity of information units [ENC_{OUT}(T)−R_{ENC,AVER}−T] by subtracting a predefined average value of the variable stream of information units in the output information stream [R_{ENC,AVER}] multiplied by the instant T, from the quantity of information units [ENC_{OUT}(T)], in accordance with the formula ENC_{OUT}(T)−R_{ENC,AVER}·T, and for calculating a modified quantity of information units [ENC_{OUT}(T)−R_{ENC,AVER}·T+ENC_{OFF}(T,ΔT)] by adding an offset value [ENC_{OFF}(T,ΔT)] to the reduced quantity of information units [ENC_{OUT}(T)−R_{ENC,AVER}·T] in accordance with the formula ENC_{OUT}(T)−R_{ENC,AVER}·T+ENC_{OFF}(T,ΔT), where the offset value [ENC_{OFF}(T,ΔT)] is chosen in dependence on values of reduced quantity of information units [ENC_{OUT}(T_{X})−R_{ENC,AVER}·T_{X}] for specific instants T_{X} within a time interval [T−ΔT,T] where ΔT represents a predefined time period, and in dependence of at least one signalizing signal [S] generated by comparing means for at least one value of modified quantity of information units [ENC_{OUT}(T_{X})−R_{ENC,AVER}·T_{X}+ENC_{OFF}(T,ΔT)];
comparing means for comparing the modified quantity of information units [ENC_{OUT}(T)−R_{ENC,AVER}·T+ENC_{OFF}(T,ΔT)] with at least one criterion and for generating at least one signalizing signal [S]; and
control means for generating at least one control signal for controlling the compression means in dependence on the state of at least one of the signalizing signals.

11. An encoding device as claimed in claim 10, characterized in that the comparing means are adapted to use a first criterion is α·T_{VB}·R_{ENC,AVER} and a second criterion is −(1−α)·T_{VB}·R_{ENC,AVER}, in which T_{VB} represents a predefined time constant and in which α represents a constant predefined value such that 0≦α≦1, and to generate
a first signalizing signal [S_{OVER}] acquiring a predetermined value if the equation
ENC_{OUT}(T)−R_{ENC,AVER}·T+ENC_{OFF}(T,ΔT)≧α·T_{VB}·R_{ENC,AVER}
is true, and to generate a second signalizing signal [S_{UNDER}] acquiring a predetermined value if the equation
ENC_{OUT}(T)−R_{ENC,AVER}·T+ENC_{OFF}(T,ΔT)≦−(1−α)·T_{VB}·R_{ENC,AVER}
is true, and in that the control means are adapted to generate
at least one control signal which influences the compression means in such a way that the maximum value of the variable stream of information units in the output information stream [R_{ENC, MAX}] will be equal to R_{ENC,AVER} if the first signalizing signal [S_{OVER}] has the predetermined value, and which influences the compression means in such a way that the minimum value of the variable stream of information units in the output information stream [R_{ENC, MIN}] will be equal to R_{ENC,AVER} if the second signalizing signal [S_{UNDER}] has the predetermined value.

12. An encoding device as claimed in claim 11, characterized in that the calculating means are adapted to chose the offset value ENC_{OFF}(T,ΔT) such that the equation
ENC_{OUT}(T_{X})−R_{ENC,AVER·}T_{X}+ENC_{OFF}(T,ΔT)≦α·T_{VB}·R_{ENC,AVER}
is true and the equation
ENC_{OUT}(T_{X})−R_{ENC,AVER}·T_{X}+ENC_{OFF}(T,ΔT)≧−(1−α)·T_{VB}·R_{ENC,AVER}
is true for all specific instants T_{X} within a time interval [T−ΔT,T].

13. An encoding device as claimed in claim 12, characterized in that the calculating means are adapted to chose the offset value ENC_{OFF}(T,ΔT) such that there exists an instant T_{MIN} within the time interval [T−ΔT,T], for which the equation ENC_{OUT}(T_{MIN})−R_{ENC,AVER}·T_{MIN}+ENC_{OFF}(T,ΔT)=−(1−α)·T_{VB}·R_{ENC,AVER} is true.

14. An encoding device as claimed in claim 11, characterized in that the device is provided with means for inputting an initial value of the recorded quantity of information units [ENC_{OUT}(0)].

15. A recording device for recording an information stream on a record carrier, comprising recording means for recording an information stream on the record carrier, characterized in that the device comprises an encoding device as claimed in claim 10.

16. A recording device as claimed in claim 15, characterized in that the device is provided with means for recording the value of the determined quantity of information units ENC_{OUT}(T)−R_{ENC,AVER}·T on the record carrier.

17. A recording device as claimed in claim 15, characterized in that the device is provided with storage means for transiently storing the information stream before recording on the record carrier.

18. A computer program product for encoding an input information stream into an output information stream, which program is operative to cause a processor to perform the method according to claim 1.
